(19) United States
(12) Patent Application Publication
(10) Pub. No.: US 2007/0061318 A1
(43) Pub. Date: Mar. 15, 2007

(54) System and method of data source agnostic querying

(76) Inventors: Soufiane Azizi, Ottawa (CA); Charles Michael Potter, Greely (CA)

Correspondence Address: PEARNE & GORDON LLP, 1801 EAST 9TH STREET, SUITE 1200, CLEVELAND, OH, 44114-3108, US

(21) Appl. No.: 11/473,562

(22) Filed: Jun. 23, 2006

(30) Foreign Application Priority Data
Sep. 13, 2005 (CA) 2,519,001

(51) Int. Cl. G06F 17/30

(52) U.S. Cl. 707/4

(57) ABSTRACT

A data source agnostic query system and method are provided. The system comprises a query set component for defining data to be retrieved from a data source. The method comprises the step of decomposing a data source agnostic query into sub-queries. The step of decomposing includes the steps of identifying the underlying data source specific planners that are involved in the preparation of the data source agnostic query and preparing the sub-queries corresponding to each planner.

### FIELD OF THE INVENTION

The invention relates generally to data access middleware and in particular to a system and method of data source agnostic querying.

### BACKGROUND OF THE INVENTION

Many organizations use data stores for storing business data, such as financial data and operational data. In order to assist business users to examine their data, various data analyzing applications are proposed. Those data analyzing applications provide various views or reports of data to users. The data analyzing applications have query engines that access the data stores to obtain desired data. Some data analyzing applications have online analytical processing (OLAP) engines to provide multidimensional views of data

Data extraction, conversion, transformation, and integration are database issues. Their solutions rely on low-level query languages: relational (such as structured query language or SQL), multidimensional (such us multi-dimensional expressions or MDX), or proprietary enterprise resource planning (ERP) application programming interfaces (APIs). Business intelligence (BI) users, systems, and applications use tools that support the following tasks:
Reporting on a wide range of data extracted from various types of database systems.
Ad-hoc querying of data residing in relational, multi dimensional, and ERP databases.
Analysis and exploration of data residing in relational, multi dimensional, and ERP databases.
Integration of data from multiple data sources into a single report or analysis session.

BI systems need to simultaneously access data from relational databases, dimensional databases, and ERP APIs. In such scenarios, a BI system would extract information from each of the data sources and then merge the results into a report However, the extraction of information from each data source is different. The BI system or a query author is presented with a query language that is tied to a specific database technology. The user interface is required to be aware of the type of data source it is reporting against and the query language or query tools used vary with the data source type. The user can be presented with a user interface that uses a semantic layer to insulate him from knowledge of low level query syntax, such us SQL or MDX. However, the user experience is inconsistent across data source types.

There is a need for a better way of providing a query that is operable for a plurality of data sources.

### SUMMARY OF THE INVENTION

In accordance with an embodiment of the present invention, there is provided a data source agnostic query system for data source agnostic querying. The system comprises a query set component for defining data to be retrieved from a data source.

In accordance with another embodiment of the present invention, there is provided a method of data source agnostic querying. The method comprises the step of decomposing a data source agnostic query into sub-queries. The step of decomposing includes the steps of identifying the underlying data source specific planners that are involved in the preparation of the data source agnostic query and preparing the sub-queries corresponding to each planner.

In accordance with another embodiment of the present invention, there is provided a memory containing computer executable instructions that can be read and executed by a computer for caring out a method of data source agnostic querying. The method comprises the step of decomposing a data source agnostic query into sub-queries. The step of decomposing includes the steps of identifying the underlying data source specific planners that are involved in the preparation of the data source agnostic query and preparing the sub-queries corresponding to each planner.

In accordance with another embodiment of the present invention, there is provided a carrier carrying a propagated signal containing computer executable instructions that can be read and executed by a computer. The computer executable instructions are used to execute a method of data source agnostic querying. The method comprises the step of decomposing a data source agnostic query into sub-queries. The step of decomposing includes the steps of identifying the underlying data source specific planners that are involved in the preparation of the data source agnostic query and preparing the sub-queries corresponding to each planner.

### BRIEF DESCRIPTION OF THE DRAWINGS

These and other features of the invention will become more apparent from the following description in which reference is made to the appended drawings wherein:

FIG. 1 shows a typical data access environment;

FIG. 2 shows in a diagram a non-data source agnostic approach to merging data source queries;

FIG. 3 shows in a block diagram a data source agnostic query system, in accordance with an embodiment of the present invention;

FIG. 4 shows in a tree diagram an example of a data source agnostic query approach, in accordance with an embodiment of the data source agnostic query system;

FIG. 5 shows in a flowchart an example of a method of data source agnostic querying, in accordance with an embodiment of the data source agnostic query system;

FIG. 6 shows in a flowchart another example of a method of data source agnostic querying, in accordance with an embodiment of the data source agnostic query system;

FIG. 7 shows in a diagram a representation of a shaped result set, in accordance with an embodiment of the data source agnostic query system;

FIG. 8 shows in a diagram an example of the organization of the rowsets in the result set, in accordance with an embodiment of the data source agnostic query system;

FIG. 9 shows in a diagram an example of the organization of the row edge rowsets, in accordance with an embodiment of the data source agnostic query system;

FIG. 10 shows in a diagram an example of a query set, in accordance with an embodiment of the data source agnostic query system;

FIG. 11 shows in a diagram an example of a query, in accordance with an embodiment of the data source agnostic query system;

FIG. 12 shows in a diagram an example of a source, in accordance with an embodiment of the data source agnostic query system;

FIG. 13 shows in a diagram an example of a selection, in accordance with an embodiment of the data source agnostic query system;

FIG. 14 shows in a diagram an example of a query result definition, in accordance with an embodiment of the data source agnostic query system;

FIG. 15 shows in a diagram an example of an edge, in accordance with an embodiment of the data source agnostic query system; and

FIG. 16 shows in a diagram an example of a value set, in accordance with an embodiment of the data source agnostic query system.

### DETAILED DESCRIPTION OF THE PREFERRED EMBODIMENTS

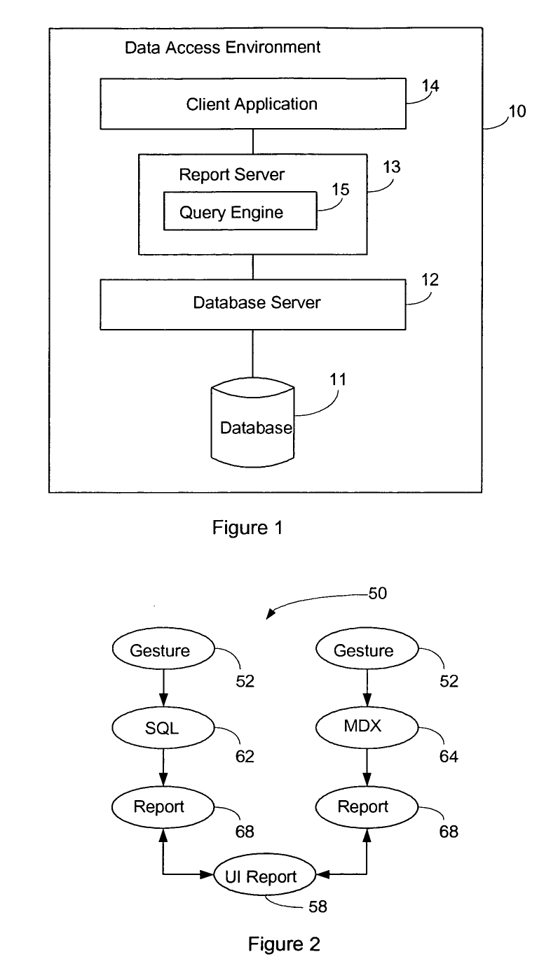

FIG. 1 shows a typical data access environment 10 for processing data Typically, data is stored in a database 11. A database server 12 uses a query language (such as a structured query language (SQL) or a multidimensional expression language (MDX)) to access the raw data stored in the database 11. A report server 13 is used to generate reports on the raw data and instruct the database server 12 to obtain information pertaining to the raw data in the database 11. An end user uses a client application 14, running on a client server, to facilitate report server 13 operations. Typically, a report server 13 has a query engine 15 for universal data access.

Data extraction, conversion, transformation, and integration are all database problems. Their solutions rely on low-level query languages: relational (such as SQL), multidimensional (MDX), or proprietary ERP APIs. BI users, systems, and applications use tools that support the following tasks:
Reporting on a wide range of data extracted from various types ofdatabase systems.
Ad-hoc querying of data residing in relational, multi dimensional, and ERP databases.
Analysis and exploration of data residing in relational, multi dimensional, and ERP databases.
Integration of data from multiple data sources into a single report or analysis session.

FIG. 2 shows in a tree diagram an example of a non-data source agnostic approach 50 to merging data source queries. Gestures 52 are translated into data source queries such as SQL 62 or MDX 64. The queries are used to generate reports 68 that are then merged into a user interface (UI) report 58.

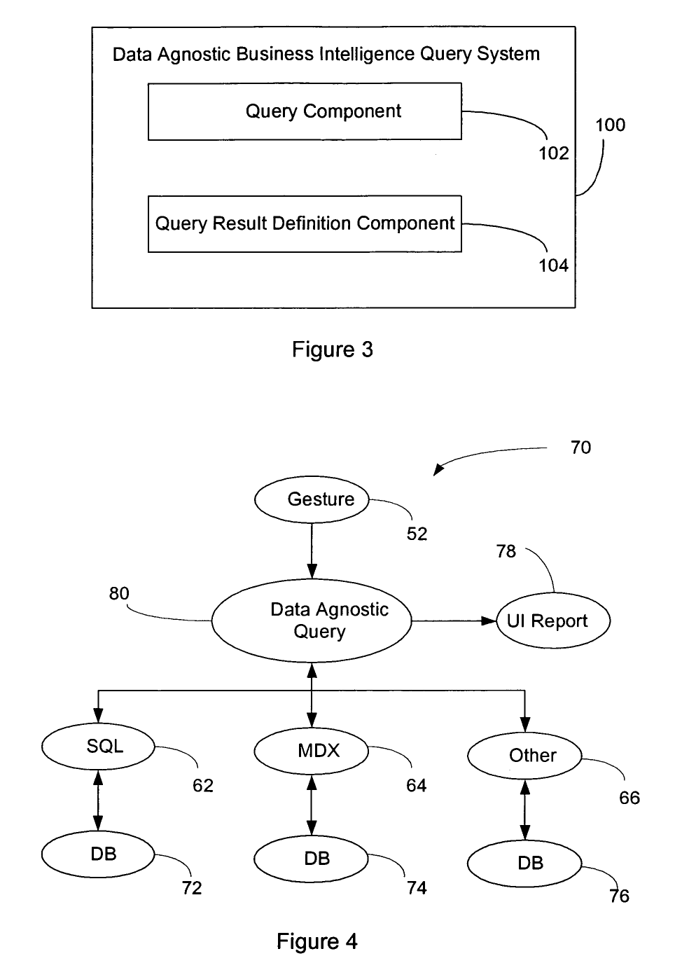

FIG. 3 shows in a block diagram an example of a data source agnostic query system 100, in accordance with an embodiment of the present invention. The data source agnostic query system 100 is suitable for fulfilling the BI user, system, or application without the need to use the low-level query languages and without the need to tailor the application for a specific data source technology. The data source agnostic query system 100 comprises a query component 102 for defming the data to be retrieved from the database, and a query result definition component 104 for describing the shape, or dimensional structure, of the result set to be returned for rendering.

FIG. 4 shows in a tree diagram an example of a data source agnostic query approach 70, in accordance with an embodiment of the data source agnostic query system 100. Gestures 52 are translated by the data source agnostic query 80 and sent to respective data source queries 62, 64, and 66 to retrieve data from the respective data sources 72, 74, 76. The retrieved information is processed and compiled into a report sent to the UI 78.

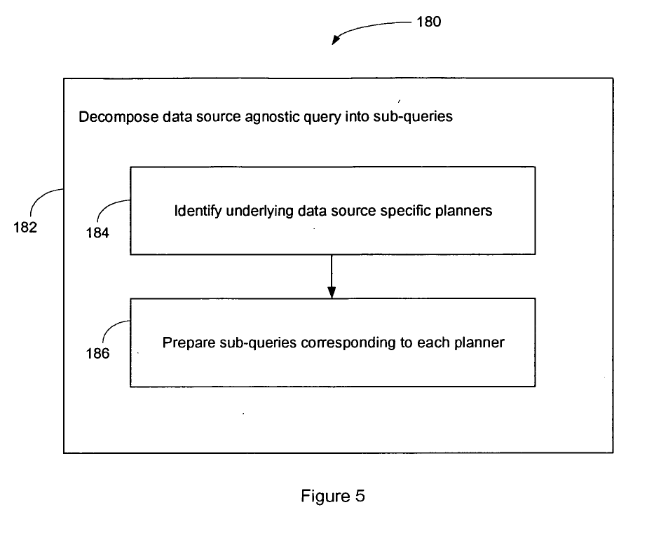

FIG. 5 shows in a flowchart an example of a method of data source agnostic querying (180), in accordance with an embodiment of the data source agnostic query system 100. A data source agnostic query is decomposed into sub-queries (182). The underlying data source specific planners that are involved in the preparation of the data source agnostic query are identified (184). Next the sub-queries corresponding to each planner are prepared (186). Other steps maybe added to the method (180).

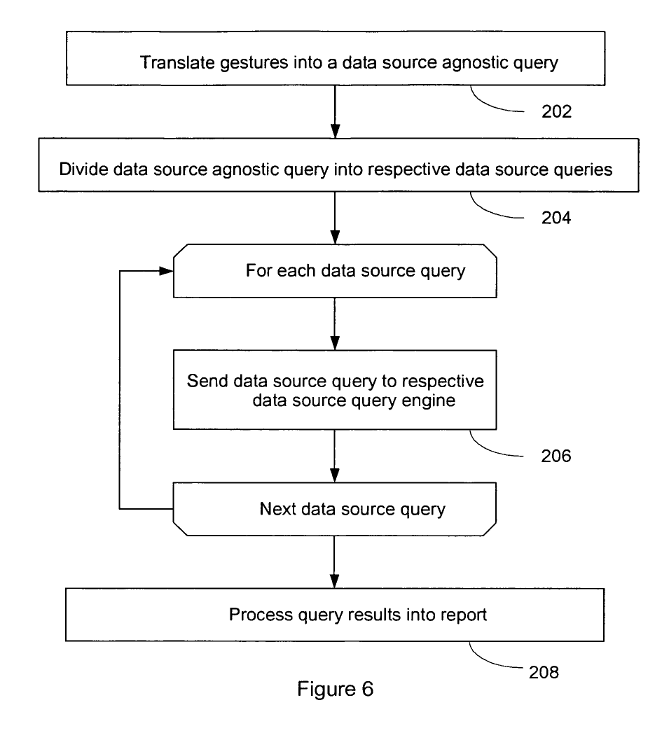

FIG. 6 shows in a flowchart another example of a method of data source agnostic querying (200), in accordance with an embodiment of the data source agnostic query system 100. The method (200) begins with translating gestures into a data source agnostic query (202). Next, the data source agnostic query is divided into respective data source queries (204). Each data source query is sent to the respective data source query engine for processing (206). The processed data is compiled into a report (208). The method is done. Other steps may be added to this method.

The data source agnostic query is a high a level query language supported for any data source agnostic application. Complex business queries are expressed easily in this query language. A data source agnostic BI query relies on the metadata model it is based on. It provides functionality for professional report authoring, casual ad-hoc querying, and sophisticated business analysis. To address the requirements of a business user, the data source agnostic BI query provides powerful query capabilities with a minimum of specifications. This implies that the data source agnostic query system 100 interprets many defaults rules in a sensible way. A single data source agnostic BI query can span multiple data source technologies and can be resolved by the query framework 100 and its stack of software components at the coordination, planning, and execution layers into multiple SQL, MDX, and vendor specific queries.

The data source agnostic BI query has the following features:
It is declarative.
It is simple enough that known database techniques for query optimization, cost estimation, and query rewriting could be extended to this query.
It provides functionality for professional report authoring, casual ad-hoc querying, and sophisticated business analysis against various data source technologies through a consistent user experience.

The data source agnostic query specification (or system 100) is encapsulated within a querySet section of the Query Service API <execute>command. This command represents a request that is submitted to the query framework, i.e., a query engine, by one of its clients. When the command is a request to retrieve the result set for the enclosed querySet, data results are returned as specified by the data source agnostic BI query result set API.

A querySet has one or more named queries (or query components 102) and one or more named queryResultDefinitions (QRDs) 104. A query 102 in the querySet defines the data to be retrieved from the data source while a QRD 104 defines the result set structure to be returned. In most cases, the query relies on the metadata model referenced in its source. The QRD 104 is the syntactic representation of the result set expected from the execution of a data source agnostic query (including data source agnostic BI query).

The QRD 104 is the main mechanism for query framework clients to tie a particular query to a particular result set. In a querySet, each QRD 104 is based on a single query that which it references. Multiple QRDs 104 in the same querySet can reference the same query 102. This allows query authors to use the same query 102 in a crosstab and a chart result sets for example. This also allows the data source agnostic query system 100 to execute a single query against a data provider and structure the results in multiple ways. A query framework API MasterDataset is returned for each queryResultDefinition specified in a querySet.

The data source agnostic query system 100 provides the ability to provide a query language that is not tailored to the data source technology that is meant to query. The data source agnostic query system 100 may be implemented as a translator in a query framework that provides the ability to build various types of BI user experiences for reporting, ad-hoc querying, and analysis that can use the query language in a consistent manner across various data source technologies. Furthermore, the query framework provides the ability to extract, convert, transform, and integrate data from multiple data sources and multiple data source types into a single report or analysis session using this high level data source agnostic query language.

The query result definition (QRD) 104, which is part of the data source agnostic query, is a data source agnostic high level definition of a rendered result set. It allows a BI system to express the structure of the results of a data source agnostic query for rendering purposes.

Advantageously, a high-level query language with rich semantics allows a business intelligence (BI) system user and/or a user interface (UI) software layer to pose BI queries to a query engine in a manner that is independent of the type of database from which the results of the query are retrieved.

Advantageously, a data source agnostic query language with minimum specification allows a BI system user to perform reporting, ad-hoc querying, analysis and exploration on top of a large array of data base technologies (relational, rollup, OLAP, HOLAP, ERP) without the need to understand SQL, MDX, or other low level query languages tied to a specific data base technology. The user experience is seamless and consistent across BI capabilities and across data source technologies.

The Query Set Component 101

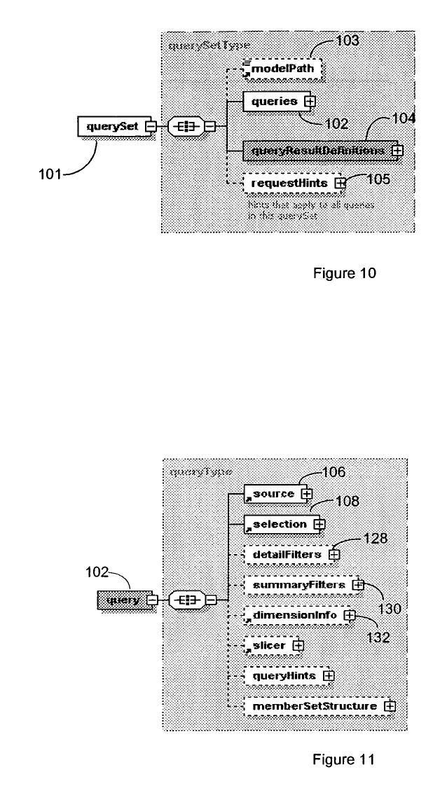

FIG. 10 shows an example of a query set component 101, in accordance with an embodiment of the data source agnostic query system 100. The query set component 101 comprises one or more query components 102 and a QRD 104. Optionally, the query set component 101 further includes a model path 103 and a request hints 105 that apply to the one or more queries 102.

FIG. 11 shows in a diagram an example of a query component 102, in accordance with an embodiment of the data source agnostic query system 100. The query component 102 includes a source 106 for defining the metadata upon which the query is based, and a selection 108 for identifying the metadata upon which the query is based. A query does not define the structure or presentation of the retrieved data. Optionally, the query component can also comprise filters, dimension information, and query hints. Preferably, each query 102 is identified by a name attribute that is unique to the querySet 101.

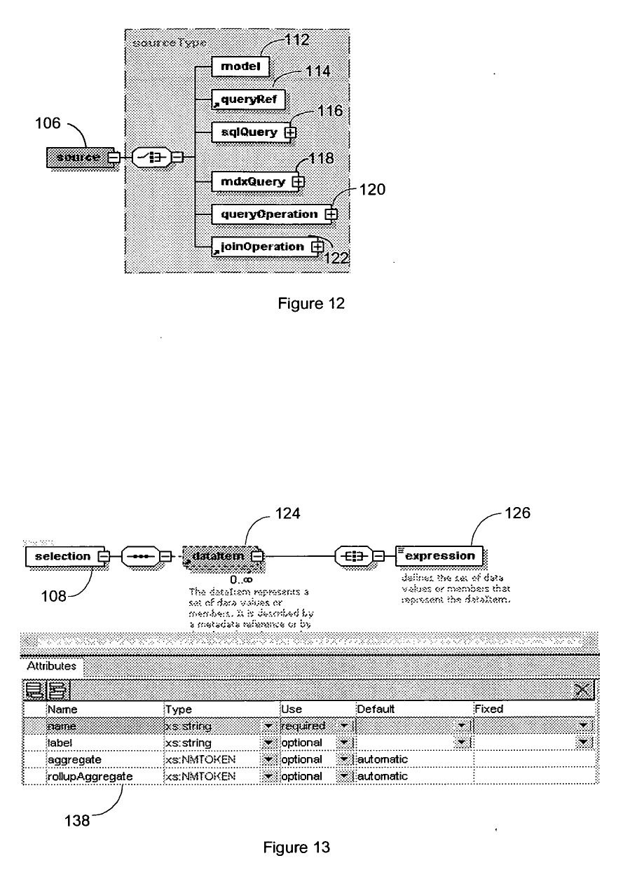

FIG. 12 shows in a diagram an example of a source 106, in accordance with an embodiment of the data source agnostic query system 100. The source 106 defines the metadata upon which the query is based. The source 106 typically is a model 112 reference, but the data source agnostic query system 100 supports the referencing of other queries 114 as well. In addition, the data source agnostic query system 100 supports direct queries against an underlying data source technology such as MDX, SQL, or a vendor interface that can be encoded within the specification. The source 106 could be the outcome of a query operation involving one or more queries followed by a unary, binary or nary commands. The result is a projection of query items that can be used by the selection and the queryResultDefinition 104.

An sqlQuery 116 is an explicit definition of a SQL select, exec or call statement that returns a row based result. The sql element contains the SQL definition as expressed in an SQL format. While not required to execute, each column in the result is preferably set to be described by a queryltem element in the projectionList so that these queryltems may be referenced in the selection and or queryResultDefinition 104.

An mdxQuery 118 is an explicit definition of an MDX statement that returns a multidimensional result. The mdx element contains the MDX definition as expressed in an MDX format. The projectionList describes the projected queryitems that can be used in the selection and queryResultDefinition 104. The dimension information describes the cube result. Queries in the query set that reference this mdxQuery 114 and use it as a source can use the dimension information as their default dimension info. They can also override, restrict, or extend it.

Query set operations 120 combine the results of two or more queries into a single result. UNION, INTERSECT, and EXCEPT (MINUS) operations on two or more queries result in a projection list upon which other queries can be based.

A join operation 122 defines a relationship between query subjects in a metadata model. Typically, these relationships are defined in the metadata model. This element is typically used to define the relationships between database tables in non-modeled data sources during a modeling application import.

FIG. 13 shows in a diagram an example of a selection 108, in accordance with an embodiment of the data source agnostic query system 100. The selection 108 identifies the metadata elements upon which the query is based. An attributes table 138 is also included in FIG. 13.

A dataItem 124 represents a set of data values or members. The data values or members that correspond to a dataItem 124 are defined by an expression element 126. The content of an expression element 126 is specified in accordance with the data source agnostic query expression grammar. Most often, a dataItem expression refers to a query item from a metadata model. Logical constructs, arithmetic operators, other query operators, and unified functions representing both relational and set (dimensional) algebra may be defined in the more complex use cases.

Aggregate functions such as total( ), minimum( ), maximum( ), count( ), average( ) are special query operations. While they can be specified in the dataItem expressions, these operators are typically specified using the aggregation rules discussed in the next section.

Each dataItem 124 is identified by a name that is unique to the selection in which the dataItem 124 is defined. It can be aliased with an alias that can be more meaningful than its name if the client application chooses to do so. References to other data items in the same selection are permissible, whether unqualified or qualified by the query name in which the dataItem is defined. Such references imply that the expression associated with the dataItem is used in place of where it is referenced. Aggregate operations of the referenced dataItem 124 are not transferred with the expression. For example:

```
<query name=“sampleQuery”>
    <source> ... </source>
    <selection autoSummary=“true”>
        <dataItem name=“Amt” aggregate=“sum”>
            <expression>[NS].[Product].[UnitPrice] *
            [Qty]</expression>
        </dataItem>
        <dataItem name=“Qty” aggregate=“sum”>
            <expression>[NS].[OrderDetail].[Quantity]</expression>
        </dataItem>
        ...
    </selection>
    ...
</query>
```

The expression for the “Amt” item refers to the “Qty” item. In one embodiment of the data source agnostic query system 100, the actual “Amt” expression that would be executed resembles:
<expression>[NS].[Product].[UnitPrice] * [NS].[OrderDetail].[Quantity]</expression>

Note that the aggregate operator that is implicit with the “Qty” item (aggregate attribute is “sum”) is not part of the resulting expression.

References to a dataItem 124 from another query must be qualified with the name of query 102 in which the dataItem 124 is defined. Following the syntax conventions currently employed, each name is enclosed in square brackets; for example, “[query].[item]“. Such references can be used anywhere that a query item reference from a metadata model is valid. The expression of the referenced dataItem 124 is used in the in place of the query item reference. For example:

```
<querySet>
    <query name=“SubQuery”>
        <source>
            <model name=“Model”/>
        </source>
        <selection autoSummary=“true”>
            <dataItem name=“Unit Price” aggregate=“sum”>
                <expression>[Model].[Product].[UnitPrice]</
                expression>
            </dataItem>
            <dataItem name=“Qty” aggregate=“sum”>
    <expression>[Model].[OrderDetail].[Quantity]</expression>
            </dataItem>
            ...
        </selection>
    </query>
    <query name=“ParentQuery”>
        <source>
            <queryRef refQuery=“SubQuery”/>
        </source>
        <selection autoSummary=“true”>
            <dataItem name=“Amt” aggregate=“sum”>
                <expression>[SubQuery].[Unit Price] *
[SubQuery].[Qty]</expression>
            </dataItem>
            ...
        </selection>
    </query>
    ...
</querySet>
```

The dataItem 124 may define the aggregation rules to be applied to the expression via the aggregate and rollupAggregate attributes. The aggregation rules suggest an aggregate function to wrap the expression when the dataItem are summarized Each attribute may specify an explicit aggregate function [automatic, summarize, none, calculated, total, minimum, maximum, average, count]. The expression itself may define the aggregate function [calculated], or the appropriate function may be derived from the underlying metadata model. In addition, aggregation may be inhibited [none], in which case the dataItem is grouped instead of summarized. Default aggregate rule is derived from the underlying metadata model. If the rollupAggregate rule is omitted, it defaults to the aggregate specification, if any; otherwise, it is also derived from the underlying metadata model.

The “automatic” and “summarize” aggregation types are reduced to the other options in accordance with defined aggregation rules.

In one embodiment of the data source agnostic query system 100, examples of aggregation types includes “none”, “calculated” and total to “count”. “none” means that no aggregation is supposed to be applied. “calculated” means that the expression content drives the expression aggregation. “total” to “count” are the standard aggregation types.

The aggregation context expression of a dataItem having one of these aggregation types (directly or as a results of interpretation of “automatic” or “summarize” aggregation types) consists of the corresponding aggregation function applied to the dataItem's expression 126. For example, the dataItem 124 defined as:

<dataItem name=“Qty” aggregate=“total”>
<expression>[GO].[OrderDetail].[Quantity]</expression>
</dataItem>

will have the aggregation context expression:
total([GO].[OrderDetail].[Quantity])

The aggregate attribute of a dataItem is ignored for an OLAP source, because the OLAP source has reduced the original data by applying this type of aggregation during building of the cube.

In a data source agnostic query, the selection 106 element by itself does not specify any result set that can be consumed by a client of the data source agnostic query system 100. A queryResultDefinition 104 is used for that purpose. In the limited sense that a selection 108 defines a data extract that can be operated on internally within the query framework system, this data extract may be sorted in the sense that the set of data values or members represented by a dataItem may be sorted The sort attnbute on each dataItem 124 may specify an ascending or descending sequence, or it may inhibit sorting on the values of that dataItem 124. This intermediary data extract that is represented by the selection 108 will be sorted according to the specifications on each dataItem, and nested in the order of the data item in the selection list. The default is unsorted. This sorting is in essence a pre-sort. It is the groupSort of the QRD 104 that affects the final sort of data values in the result set of the query.

In a data source agnostic query, the selection 108 by itself does not specify any result set that can be consumed by a client of the data source agnostic query system 100. A queryResultDefinition 104 is used for that purpose. In the limited sense that a selection defines a data extract that can be operated on internally within the query framework, this data extract may be grouped and summarized automatically—an all-or-nothing operation that is controlled by the autoSummary attribute. When enabled, all non-additive dataItems 124 will be grouped into a single summary level, and the additive and semi-additive dataItems 124 are summarized. The result set will contain a single row for each unique combination of the non-additive dataItem values, and an aggregate value for each additive or semi-additive dataItem. When disabled, the individual database records will be extracted as they appear in the database. The default is enabled (”true”). When the data item expression identifies a single member value or a specific member set, the auto Summary attribute has no meaning.

A query 102 may contain one or more filters that eliminate data values or members from the result set and potentially affect the values of calculations. Each filter element contains at least one filterExpression. Two or more filterExpressions specified within a filter are conjoined via AND operators. Multiple filter specifications are also conjoined via AND operators. Any filter or filterExpression may be designated as optional, in which case it is not applied when no values are provided for the parameters to which the filter or filterExpression refers.

Logically, one can think of the set of related queries 102 in a querySet 101 as blocks of operations and transformations performed on a data stream. In this logical representation, the querySet 101 can be visualized as a tree of query operations where each node, represented by a <query>, performs operations and transformations on an input data stream defined in its source section then feeds the resulting output data stream to the next query node, which uses it as an input data stream. At the end of this process, a QRD 104 is defined to represent the structure of the last output data stream for authoring purposes. Filtering and aggregation are two special query operations performed by a query node in this logical tree. It is important to clearly specify their order. To do so, a detail filter 128 is defined which is applied at the input data stream of a query node and hence before any calculations and aggregations are performed in that node. A summary filter 130 is also defined, which is performed after aggregations. This summary filter 130 is logically equivalent to the detail filter of the next query node that consumes the output data stream of the current node.

A query author can control the order in which filtering and aggregation should occur by using this mechanism in the data source agnostic query querySet (i.e., query based on query also known as subquery). In one embodiment, some sensible defaults and interpretations are provided for cases where the query author would like a minimum specification in a single query. The author might not seek a granular control over desired query operations expressions.

Without the optional level attribute, a detailFilter 128 defines filters that are applied to the source of a query, before any aggregates are calculated. If the selection 108 is summarized (autoSummary), this filter inhibits source data values or members from participating in the calculation of the aggregate values; otherwise, it inhibits source data values or members from appearing in the data extract represented by the selection.

The detailFilter 128 can optionally specify the level at which the filter is applied. If unspecified, the overall (or root) level of a dimension is assumed.

Without the optional level attribute, a summaryFilter 130 defines filters that are applied after aggregates are calculated, also known as a post-aggregation filter. Logically, while the detailFilter 128 is applied to the input data stream of a query, the summary filter 130 is applied to its output. This distinction and the timing of the filter operation are critical only with respect to the aggregate calculation operation. For example, the final output of the query operations represented by a query 102 is not affected by whether we sort then filter or conversely, we filter then sort Performance requirements dictate that the latter is chosen during query planning; however, one sequence or the other does not affect the result set.

Typically, in most practical cases, the query author specifies single query in the querySet 101 to define the data to be retrieved from the database, and a single QRD 104 to define the result set structure. Headers and Footers are specified in the QRD 104 that represent aggregations at various nesting levels of the result set. In these cases, a detailFilter 128 is applied to the data values (rows or members) in the data source, while a summaryFilter 130 is applied to the footer or header values, which represent aggregate calculations. The summaryFilter 130 can optionally specify the level at which the filter is applied. If unspecified, the overall (or root) level of a dimension is assumed Calculations at and above the specified levels are subject to the filter conditions (i.e., their values can be changed due to the filter condition).

Dimension information 132 augments the selection 108 . It is optional and is specified by an advanced query author when
There is no dimension information available in the source.
The author wishes to override the dimension information in the source.
The author wishes to extend or restrict dimension information in the source.

The intent of dimension information 132 is not to define the presentation of the information, but to help query planning. In other words it can be considered a form of hint. If the dimension information 132 is omitted then dimension information is used from the source if available. If not available, it will be defaulted by the query framework system.

A data source agnostic query will undergo a series of transformations before SQL, MDX, and or vendor specific APIs are produced and sent to the database. For example, a join strategy must be derived from the underlying metadata. In addition, the generated query may be optimized to better retrieve the first N rows rather than all rows, push most operations to the database, or automatically sort based upon group by structure. These algorithms may be controlled through rowLimit, executionOptimization, queryProcessing, autoSort, joinOptimization and subjectordering hints.

The Query Result Definition Component 104

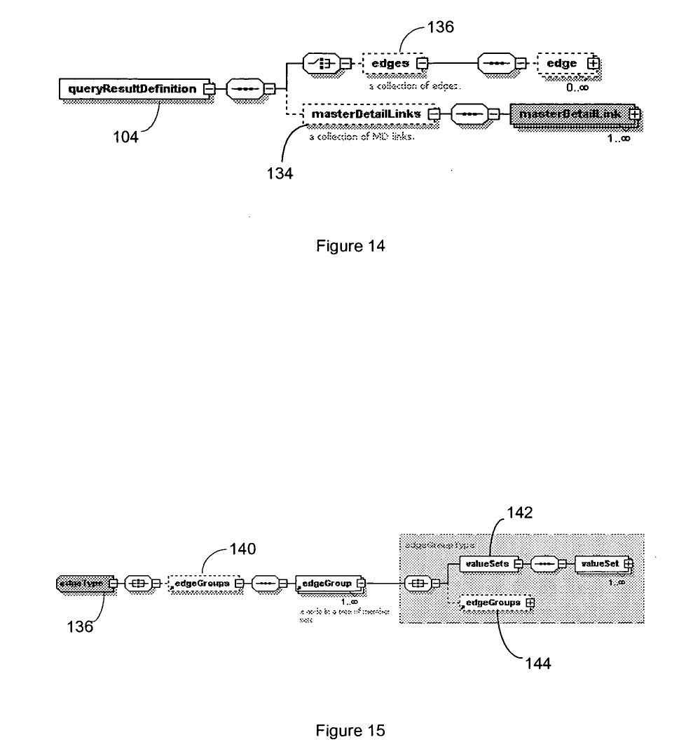

FIG. 14 shows in a diagram an example of a QRD component 104, in accordance with an embodiment of the data source agnostic query system 100. The query result definition (QRD) component 104 describes the shape, or the dimensional structure, of the result set to be returned for rendering. It is generally generated from the layout specification and is used to assist the rendering operation by delivering the data to be iterated in the expected form. The QRD 104 unambiguously specifies a result set structure and represents a meta-model of the data source agnostic query result set API.

In non-data source agnostic query architecture, there is a disconnect between the manner in which queries were posed in a request to a common query engine and how data is returned via the query set API. The intent with the data source agnostic query result set API is to align it with the data source agnostic query specification such that there is a correspondence between the structure of the queryResultDefinition 104 of the data source agnostic query and the objects presented in the master/partial datasets of the result set API.

The QRD 104 can be specified either as one of the available templates or as a set of named canonical edges. The template specification is meant to provide the authoring tools and the software developer kit (SDK) with a simple specification for the most common use cases. The QRD 104 can contain optional master-detail links, generated from the layout containment relationships, which define the master and detail contexts of the relationships. The master-detail links 134 can be specified equivalently in the QRD 104 of the master or detail query.

Simple list, grouped list, and cross tab results can be specified in a QRD 104 in a unified manner using the canonical edge specification. Simple and grouped list results have a single edge. A cross tab result has two or more edges 136 (row, column, section 1 to section N). These edges 136 are uniquely named. The order in which the edges 136 are specified in the QRD 104 is also the order in which they appear in the result set. The edge information in the result set contains the unique name of the edge as specified in the QRD 104. A query framework 100 client can use the edge's unique name to relate the edges 136 specified in the QRD 104 and the edges returned in the result set. A cross tab with an empty row or column edge can be specified with a named empty edge <edge name=“row”/>. A single edge cross tab and a grouped list with no details are represented by the same canonical edge specification. The result sets for a single edge cross tab and a grouped list with no detail columns are also represented by the same result set API structure.

FIG. 15 shows in a diagram an example of an edge 136 type, in accordance with an embodiment of the data source agnostic query system 100. An edge 136 has a list of one or more edgeGroups 140. These are the outer-most groups in the edge 136. They represent member sets (or data values) that are unioned together. Each one of these edgeGroups 140 has one or more valueSets 142 (that are also unioned within the edgeGroup), and one or more edgeGroups 144 that are nested or cross joined within the valueSets 142. In other words, the edge represents an arbitrary shaped result set, which is composed by stitching and intersecting sets of members.

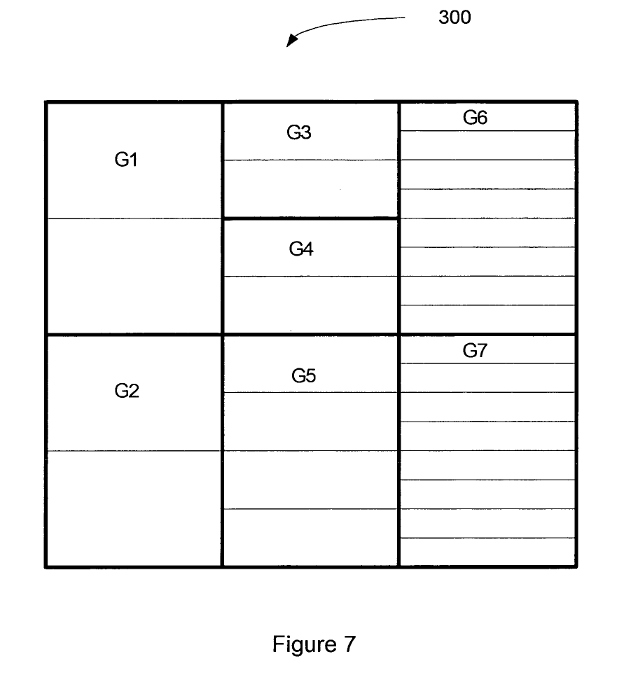

FIG. 7 shows in a diagram a representation of a shaped result set 300, in accordance with an embodiment of the data source agnostic query system 100. An example of a QRD 104 for this case is the following:

```
<queryResultDefinition xmlns:xsi=“http://www.w3.org/2001/
XMLSchema-instance”
xsi:noNamespaceSchemaLocation=“E:\bering\bering_v5_specs\main\
QuerySpec\V5QueryResultDefinition.xsd” name=“SampleQRD”
refQuery=“Don'tCare”>
    <edges>
        <edge name=“axis0”>
            <edgeGroups>
                <edgeGroup>
                    <valueSets>
                        <valueSet refDataItem=“G1”/>
                    </valueSets>
                    <edgeGroups>
                        <edgeGroup>
                            <valueSets>
                                <value Set
refDataItem=“G3”/>
                                <valueSet
refDataItem=“G4”/>
                            </valueSets>
                            <edgeGroups>
                                <edgeGroup>
                                    <valueSets>
                                        <valueSet
refDataItem=“G6”/>
                                    </valueSets>
                                </edgeGroup>
                            </edgeGroups>
                        </edgeGroup>
                    </edgeGroups>
                </edgeGroup>
                <edgeGroup>
                    <valueSets>
                        <valueSet refDataItem=“G2”/>
                    </valueSets>
                    <edgeGroups>
                        <edgeGroup>
                            <valueSets>
                                <valueSet
refDataItem=“G5”/>
                            </valueSets>
                            <edgeGroups>
                                <edgeGroup>
                                    <valueSets>
                                        <valueSet
refDataItem=“G7”/>
                                    </valueSets>
                                </edgeGroup>
                            </edgeGroups>
                        </edgeGroup>
                    </edgeGroups>
                </edgeGroup>
            </edgeGroups>
        </edge>
    </edges>
</queryResultDefinition>
```

The data source agnostic query result set API presents each group as a rowset that can be iterated using an IRSSetIterator object. Group headers and footers are presented as separate rowsets that can be accessed within context of a group's corresponding rowset. The name of the rowset corresponding to a group is unique and is that of the dataItemRef of the valueSet that represents the level key of the group in the QRD 104, making it clear to the client application how the data in the result set corresponds to the layout specification.

Just as the data source agnostic query specification maintains a consistent approach to specifying groups in both list and cross tab queries, the data source agnostic query result set API presents a single approach to iterating values in a list report as when iterating values along the edges of a cross tab report. In the data source agnostic query result set API, list reports are accessed via the same IRSSetIterator class that is used to navigate the edges of cross tab result sets. At any grouping level (represented by a separate rowset), header and footer values may be obtained at any time. All of the detail rows of a report are contained in the single, innermost rowset named “details”.

In the data source agnostic query result set API, there are no restrictions on how rowsets are related. The result set is instead restricted by what can be authored in the data source agnostic query specification.

An edgeGroup 140 represents an arbitrary shaped set of members (data values) on an edge 136. A flat list of non-nested edge groups in an edge specification can be used to represent the unioning of member sets. Each group can have one or more valueSets 142 that represent the group's members (based on a caption key and associated body attributes), an optional header and/or footer, a sort, and suppression. Each group can also have one or more nested groups.

An explorer-mode cross tab edge can be specified by a set of nested edge groups. By nesting and unioning edge groups, a query framework client can specify a reporter-mode crosstab edge.

A grouped list report can be specified by a set of nested edge groups with the inner most edge group representing the details. This special group is not keyed on any level (i.e., it valueSet has not refDataItem attribute) and its body references the detail columns as level attributes.

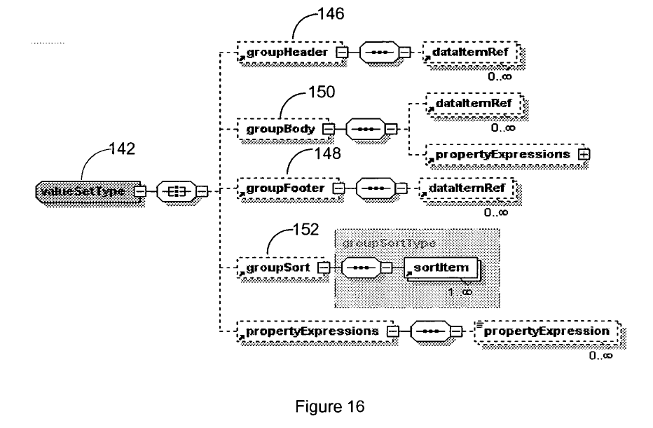

FIG. 16 shows in a diagram an example of a valueSet 142 type, in accordance with an embodiment of the data source agnostic query system 100. The valueSet 142, also known as a memberSet, defines a collection of values or members to be returned for an edgeGroup140. It represents a (nesting) level in an explorer style edge. The refDataItem attribute of this element represents the “key” associated with the level. The name attribute identifies the valueSet within the QRD 104, and is unique within the scope of the QRD 104.

The groupHeader 146 and groupFooter 148 child elements of the valueSet 142 element define a set of data values or members that represents a summary of the group members.

The groupBody 150 child element of the valueSet element defines the attributes to be returned for each member in the group.

The groupSort 152 child element of the valueSet element defines the sort order for the group members within a context defined by the entire result set. A query author can define a sort using projected and non projected items. The groupSort 152 can reference a data item form the associated query 102 even if the data item was not used in QRD 104. For a detail group (i.e., a group with a valueSet 142 that has no data item reference and has a group body reference a list of items) the order of the groupSort 152 items dictates the order in which the details are sorted.

In one embodiment, queryResultDefinition 104 templates represent a choice of one of three basic templates that cover the most common report types (lists, cross tabs, charts they are meant to provide authoring tools and the SDK with simple specifications for the most common use cases.

Use Cases

Simple List

One basic data source agnostic query that may be specified is the Simple List. The result set may contain summary or detail database rows (autoSummary). In both cases, the result set structure is the same as defined by the QRD 104. One grouping level may be specified. Any aggregate specifications are applicable only to the lowest grouping level in a summary query—since there's only one grouping level, control break aggregates at various grouping levels are not supported. The next example is of a Simple List report containing [Order year], [Order method], and [Quantity].

| Order year | Order method | Quantity |
|---|---|---|
| 2000 | E-mail | 86,884 |
| 2000 | Fax | 34,462 |
| 2000 | Mail | 54,874 |
| 2000 | Sales visit | 135,262 |
| 2001 | E-mail | 122,350 |
| 2001 | Fax | 41,558 |
| 2001 | Mail | 43,672 |
| 2001 | Sales visit | 191,578 |
| 2002 | E-mail | 139,086 |
| 2002 | Fax | 39,824 |
| 2002 | Mail | 25,684 |
| 2002 | Sales visit | 208,858 |

The QRD 104 for this example (using canonical edge specification) is the following:

```
<queryResultDefinitions>
    <queryResultDefinition name=“rs1” refQuery=“query1”>
            <edges>
                <edge name=“edge0”>
                    <edgeGroups>
                        <edgeGroup>
                            <valueSets>
                                <valueSet>
                                    <groupBody>
                                        <dataItemRef
refDataItem=“Order Year”/>
                                        <dataItemRef
refDataItem=“Order Method”/>
                                        <dataItemRef
refDataItem=“Quantity”/>
                                    </groupBody>
                                </valueSet>
                            </valueSets>
                        </edgeGroup>
                    </edgeGroups>
                </edge>
            </edges>
        </queryResultDefinition>
    </queryResultDefinitions>
</querySet>
```

The QRD for this example (using the list template specification) is the following:

```
    <queryResultDefinitions>
        <queryResultDefinition name=“rs1” refQuery=“query1 ”>
            <resultTemplate>
                <listResult>
                    <details>
                        <dataItemRef refDataItem=“Order Year”/>
                        <dataItemRef refDataItem=“Order
Method”/>
                        <dataItemRef refDataItem=“Quantity”/>
                    </details>
                </listResult>
            </resultTemplate>-
        </queryResultDefinition>
    </queryResultDefinitions>
</querySet>
```

Grouped List

The next example is of a list report containing [Order year], [Order method], and [Order year] and with a report level summary.

| Order year | Order method | Quantity |
|---|---|---|
| 2000 | E-mail | 86,884 |
| | Fax | 34,462 |
| | Mail | 54,874 |
| | Sales visit | 135,262 |
| 2000 | | 311,482 |
| 2001 | E-mail | 122,350 |
| | Fax | 41,558 |
| | Mail | 43,672 |
| | Sales visit | 191,578 |
| 2001 | | 399,158 |
| 2002 | E-mail | 139,086 |
| | Fax | 39,824 |
| | Mail | 25,684 |
| | Sales visit | 208,858 |
| 2002 | | 413,452 |

| | |
|---|---|
| Summary | 1,123,872 |

The QRD 104 for this example (using canonical edge specification) is the following:

```
<queryResultDefinition name=“groupedList” refQuery=“some query”>
    <edges>
        <edge name=“edge0”>
            <edgeGroups>
                <edgeGroup>
                    <valueSets>
                        <valueSet refDataItem=“Order Year”>
                            <groupFooter>
                                <dataItemRef
refDataItem=“Quatity”/>
                            </groupFooter>
                        </valueSet>
                    </valueSets>
                    <edgeGroups>
                        <edgeGroup>
                            <valueSets>
                                <valueSet>
                                    <groupBody>
                                        <dataItemRef
refDataItem=“Order Method”/>
                                        <dataItemRef
refDataItem=“Quantity”/>
                                    </groupBody>
                            </valueSets>
                        </edgeGroup>
                    </edgeGroups>
                </edgeGroup>
            </edgeGroups>
        </edge>
    </edges>
</queryResultDefinition>
```

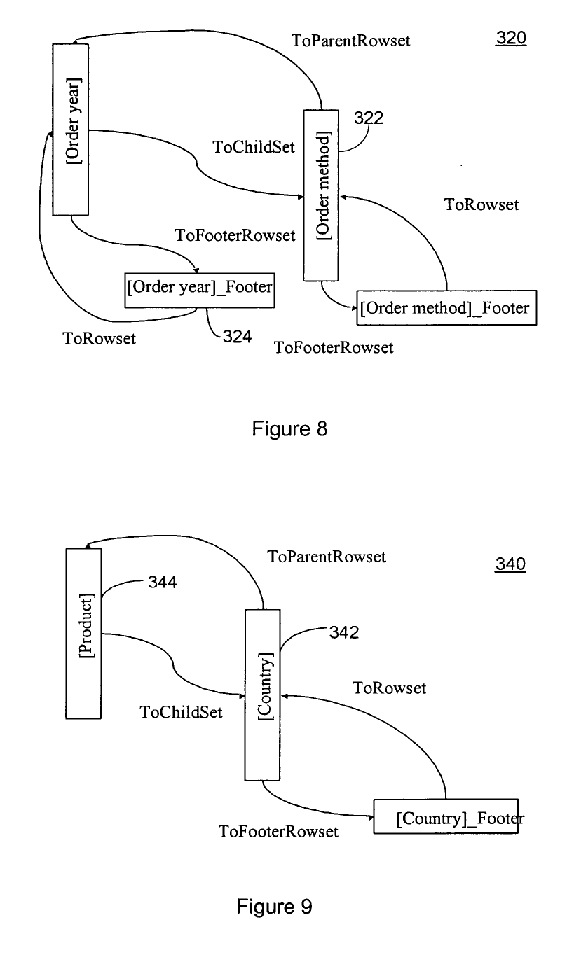

FIG. 8 shows in a diagram an example of the organization of the rowsets in the result set 320, in accordance with an embodiment of the data source agnostic query system 100. Note that the [Order method] rowset 322 contains both the [Order method] and [Quantity] data sets from the QRD 104. Also, the [Order year]_Footer rowset 324 contains one row of data that represents the report summary.

Crosstab

A cross tab result presents a grid of summarized data values: effectively, it is an intersection of two Grouped List results. A QRD 104 with two or more edges defines a cross tab result. Aggregates at various intersections are calculated automatically This example is the same as the previous example, except the data is presented as a cross tab.

| | | Quantity |
|---|---|---|
| 2000 | E-mail | 86,884 |
| | Fax | 34,462 |
| | Mail | 54,874 |
| | Sales visit | 135,262 |
| | 2000 | 311,482 |
| 2001 | E-mail | 122,350 |
| | Fax | 41,558 |
| | Mail | 43,672 |
| | Sales visit | 191,578 |
| | 2001 | 399,158 |
| 2002 | E-mail | 139,086 |
| | Fax | 39,824 |
| | Mail | 25,684 |
| | Sales visit | 208,858 |
| | 2002 | 413,452 |

| | |
|---|---|
| Order Year | 1,123,872 |

The QRD 104 for this example (using canonical edge specification) is the following:

```
<queryResultDefinition name=“groupedList” refQuery=“some query”>
    <edges>
        <edge name=“edge0”>
            <edgeGroups>
                <edgeGroup>
                    <valueSets>
                        <valueSet refDataItem=“Order Year”>
                        <valueSet refDataItem=“Order Year”>
                            <groupFooter>
                                <dataItemRef
refDataItem=“Quatity”/>
                            </groupFooter>
                        </valueSet>
                    </valueSets>
                    <edgeGroups>
                        <edgeGroup>
                            <valueSets>
                                <valueSet
refDataItem=“Order Method”>
                                    <groupFooter>
                                        <dataItemRef
refDataItem=“Order Year”/>
                                    </groupFooter>
                                </valueSet>
                            </valueSets>
                        </edgeGroup>
                    </edgeGroups>
                </edgeGroup>
            </edgeGroups>
        </edge>
        <edge name=“edge1”>
        <edgeGroups>
            <edgeGroup>
                <valueSets>
                    <valueSet refDataItem=“Quantity”></valueSet>
                </valueSets>
            </edgeGroup>
        </edgeGroups>
        </edge>
    </edges>
</queryResultDefinition>
```

The representation of the rowsets is identical to the previous example, except that the [Order method] rowset 322 no longer contains the [Quantity] column—those values are now contained within a cell rowset iterator.

Crosstab 2

FIG. 9 shows in a diagram an example of the organization of the row edge rowsets 340, in accordance with an embodiment of the data source agnostic query system 100. This example presents simple cross tab report with [Country] 342 nested within [Quantity] along the column edge. Sub-totals are calculated for each product.

| | | Quantity |
|---|---|---|
| Product1 | USA | 1000 |
| | Canada | 500 |
| | France | 2000 |
| | Total | 3500 |
| Product2 | USA | 3000 |
| | Canada | 2000 |
| | France | 500 |
| | Total | 5500 |

The QRD 104 for this example (using canonical edge specification) is the following:

```
<queryResultDefinition name=“groupedList” refQuery=“some query”>
    <edges>
        <edge name=“rows”>
            <edgeGroups>
                <edgeGroup>
                    <valueSets>
                        <valueSet refDataItem=“Product”/>
                    </valueSets>
                    <edgeGroups>
                        <edgeGroup>
                            <valueSets>
                                <valueSet
refDataItem=“Country”>
                                    <groupFooter>
                                    </groupFooter>
                                </valueSet>
                            </valueSets>
                        </edgeGroup>
                    </edgeGroups>
                </edgeGroup>
            </edgeGroups>
        </edge>
        <edge name=“columns”>
        <edgeGroups>
            <edgeGroup>
                <valueSets>
                    <valueSet refDataItem=“Quantity”></valueSet>
                </valueSets>
            </edgeGroup>
        </edgeGroups>
        </edge>
    </edges>
</queryResultDefinition>
```

Notice the empty group footer for the country valueSet. It indicates that the rowset corresponding to this footer should have zero columns, which is a valid case. Consumers of this result set will use the existence of this empty rowset to form grouping breaks for example when rendering such a result set.

The systems and methods according to the present invention may be implemented by any hardware, software or a combination of hardware and software having the functions described above. The software code, either in its entirety or a part thereof, may be stored in a computer readable memory. Further, a computer data signal representing the software code that may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

What is claimed is:

1. A data source agnostic query system for data source agnostic querying, the system comprising:
a query set component for defining data to be retrieved from a data source.

2. The data source agnostic query system as claimed in claim 1, wherein the query set component includes a set of queries, the queries having:
a source element for defining metadata upon which the data source agnostic query is based; and
a selection element for identifying metadata elements upon which the data source agnostic query is based.

3. The data source agnostic query system as claimed in claim 2, wherein the queries further includes one or more of:
a name attribute for uniquely identifying the queries in the query set component;
a detail filter element for eliminating data values or members from a result set;
a summary filter element for eliminating data values or members from a result set;
a slicer element for slicing on data values or members from a result set;
a dimension information element for augmenting the selection element;
a memeberSet Structure that describes the set structure of the query; and
a query hint element for transforming the data source agnostic query.

4. A data source agnostic query system for data source agnostic querying, the system comprising:
a query result definition component for describing the structure of a result set for the data to be retrieved.

5. The data source agnostic query system as claimed in claim 4, wherein the query result definition further includes one or more of:
edges for defining the placement of data items within a report; and
master detail links for master-detail relationships between the queries in a query set.

6. The data source agnostic query system as claimed in claim 5, wherein the edge is a collection of edge groups, each edge group having:
a collection of value sets and;
a collection of nested edges groups.

7. The data source agnostic query system as claimed in claim 6, wherein a value set of the collection of value sets includes one or more of:
a group header for containing a collection of data item references;
a group footer for containing a collection of data item references;
a group body for containing a collection of data item references and a collection of property expressions;
a group sort for containing a collection of sort items, and
a collection of property expressions.

8. A data source agnostic query system for data source agnostic querying, the system comprising:
a query set component for defining data; and
a query result definition component for describing the structure of a result set.

9. A method of data source agnostic querying, the method comprising the step of decomposing a data source agnostic query into sub-queries, the step of decomposing including the steps of:
identifying the underlying data source specific planners that are involved in the preparation of the data source agnostic query; and
preparing the sub-queries corresponding to each planner.

10. The method claimed in claim 9 wherein the sub-queries are grouped into data source query types.

11. The method claimed in claim 9 wherein the decomposition has intimate knowledge of the quality of service of all underlying source.

12. The method claimed in claim 9 wherein the decomposition uses the QRD and the data item expressions for optimization.

13. The method as claimed in claim 9, further comprising the step of:
translating the gesture into a data source agnostic query.

14. The method as claimed in claim 9, further comprising the step of:
sending each sub-query to a data source query engine based upon its data source query type.

15. The method as claimed in claim 14, further comprising the step of:
reassembling of the results from the data source query engines into a single result set and the decomposed plan

16. The method as claimed in claim 9, further comprising the steps of:
receiving a data set result from the data source query engine; and
compiling the data set result into a report.

17. A memory containing computer executable instructions that can be read and executed by a computer for caring out a method of data source agnostic querying, the method comprising the step of:
decomposing a data source agnostic query into sub-queries, the step of decomposing including the steps of:
identifying the underlying data source specific planners that are involved in the preparation of the data source agnostic query; and
preparing the sub-queries corresponding to each planner.

18. A carrier carrying a propagated signal containing computer executable instructions that can be read and executed by a computer, the computer executable instructions being used to execute a method of data source agnostic querying, the method comprising the step of:
decomposing a data source agnostic query into sub-queries, the step of decomposing including the steps of:
identifying the underlying data source specific planners that are involved in the preparation of the data source agnostic query; and
preparing the sub-queries corresponding to each planner.
